(19) United States
(12) Patent Application Publication
(10) Pub. No.: US 2015/0379618 A1
(43) Pub. Date: Dec. 31, 2015

(54) DEVICE, SYSTEM, AND METHOD OF CONVERTING ONLINE BROWSING TO OFFLINE PURCHASES

(71) Applicant: HUNT LTD., Bnei Brak (IL)

(72) Inventor: Adriana Neumann, Tel Aviv (IL)

(21) Appl. No.: 14/765,338

(22) PCT Filed: Feb. 9, 2014
(86) PCT No.: PCT/IB2014/058874

§ 371 Date: Aug. 2, 2015

Related U.S. Application Data
(60) Provisional application No. 61/764,564, filed on Feb. 14, 2013.

(51) Int. Cl. G06Q 30/06; G06Q 30/02

(52) U.S. Cl. CPC G06Q 30/0639; G06Q 30/0623; G06Q 30/0257

(57) ABSTRACT

A user utilizes an electronic device in order to browse an online store and to tag images of products, by selecting such images, or by dragging-and-dropping such images onto a dedicated on-screen toolbar. The tagged images from multiple online stores are stored in a repository, together with data identifying the tagged products, their prices, and the online stores that sell the tagged products. A matching module determines which offline stores sell the tagged products. In response to a user command, a digital map is generated, showing offline stores which sell offline the tagged product and which are located within a user-defined distance from a particular user-defined geographical location.

### CROSS-REFERENCE TO RELATED APPLICATIONS

This application claims priority and benefit from U.S. provisional patent application No. 61/764,564, filed on Feb. 14, 2013, which is hereby incorporated by reference in its entirety.

### FIELD OF THE INVENTION

The present invention relates to the field of online and offline shopping.

### BACKGROUND

Millions of people shop online by purchasing goods, for example, from online retailers who operate Internet web-sites. Internet-based commerce and electronic commerce has grown significantly in the past decade, through online vendors (e.g., Amazon.com or eBay.com), as well as through offline retailers that also operate an online store (e.g., Walmart.com or Target.com).

Millions of people shop offline, by visiting a brick-and-mortar store, hand-picking an item offered for purchase, and paying at a cash register or other Point-of-Sale (PoS) terminal that is typically operated by a store employee.

### SUMMARY

The present invention may comprise, for example, devices, systems, and methods for converting online browsing for items to be purchased, to actual real-world non-virtual offline purchases of such items at brick-and-mortar store(s).

For example, a user utilizes an electronic device in order to browse an online store and to tag images of products, by selecting such images, or by dragging-and-dropping such images onto a dedicated on-screen toolbar. The tagged images from multiple online stores are stored in a repository, together with data identifying the tagged products, their prices, and the online stores that sell the tagged products. A matching module determines which offline stores sell the tagged products. In response to a user command, a digital map is generated, showing offline stores which sell offline the tagged product and which are located within a user-defined distance from a particular user-defined geographical location.

In some embodiments, a method may comprise: receiving from a user of an electronic device, multiple selections of multiple products that are offered for sale online on multiple different websites; receiving from the user of the electronic device an indication of a desired geographical location; generating a digital map which shows multiple offline stores which (A) are located within a user-defined distance from the desired geographical location and also (B) offer for offline sale said multiple products.

In some embodiments, the method may comprise: receiving from the electronic device of a user, a first user selection of an image of a first product offered for sale on a first online store; storing in a repository a first record indicating at least (a) an identification of said first product, and (b) an identification of said first online store; receiving from the electronic device of the user, a second user selection of an image of a second product offered for sale on a second online store; storing in said repository a second record indicating at least (a) an identification of said second product, and (b) an identification of said second online store; receiving from the user an indication of a desired geographical location; determining a first location of a first offline store which is (A) associated with the first online store, and (B) is within a pre-defined distance from the desired geographical location; determining a second location of a second offline store which is (A) associated with the second online store, and (B) is within said pre-defined distance from the desired geographical location; generating a digital map indicating at least (i) the desired geographical location, (ii) the first location of the first offline store, (iii) the second location of the second offline store.

In some embodiments, the method may comprise: determining that the user is located indoor and within premises of the first location of the first offline store; automatically displaying to the user, the first image of the first product.

In some embodiments, the method may comprise: while the user is located within the first location of the first offline store, generating a promotional proposal directed specifically to said user based on previous online selection of said first product by said user

In some embodiments, the method may comprise: automatically sending a notification to an electronic device of said first location of first offline store, notifying that (A) said user is within premises of said offline store, and (B) that said user had performed online selection of said first product.

In some embodiments, the method may comprise: if the user purchases said first product at said first offline store, sending a notification to said first location of said offline store, indicating that a commission is due for converting (A) a previous online browsing and online tagging of the first product by the user, into (B) a current sale of said first product to said user at said first location of the offline store.

In some embodiments, determining that the user is located indoor and within premises of the first location of the first offline store comprises: based on a user-initiated scanning of a two-dimensional barcode located in said first offline store, determining that the user is located indoor and within premises of the first location of the first offline store.

In some embodiments, determining that the user is located indoor and within premises of the first location of the first offline store comprises: receiving from the user a notification that the user arrived to said first location of the first offline store.

In some embodiments, determining that the user is located indoor and within premises of the first location of the first offline store comprises: based on Global Positioning System (GPS) data of said electronic device of said user, determining that the user is located within premises of the first location of the first offline store.

In some embodiments, determining hat the user is located indoor and within premises of the first location of the first offline store comprises: based on identification of a wireless communication network accessible from said first offline store, determining that the user is located within premises of the first location of the first offline store.

In some embodiments, the method may comprise: wirelessly receiving from said electronic device of said user, a user command to perform an online purchase of said first product from said first online store; in response to said user command, initiating on behalf of said user an online purchase of said first product from said first online store which corresponds to said first offline store that said user is visiting.

In some embodiments, receiving from the electronic device the first user selection of the image of the first product comprises: displaying on said electronic device, together with a web-page of said first online store, an on-screen toolbar onto which website images can be selectively dragged-and-dropped by said user via said electronic device; receiving from the electronic device an indication that the user drags-and-drops the image of the first product onto said on-screen toolbar.

In some embodiments, receiving from the electronic device the first user selection of the image of the first product comprises: displaying on said electronic device, together with a web-page of said first online store, a symbol overlaid on top of a portion of said image of the first product, wherein the symbol indicates to said user that said image can be selected; receiving a user command via said electronic device, to select said symbol overlaid on top of said portion of said image of the first product.

In some embodiments, method may comprise: receiving from said user an indication that the first product is a mandatory product; receiving from said user an indication that the second product is an optional product; wherein the generating of the digital map comprises: generating the digital map which (A) includes the first offline store selling said mandatory product, and (B) excludes the second offline store selling said optional product.

In some embodiments, the method may comprise: prior to generating the digital map, receiving from said electronic device a user-defined map generation constraint; wherein the generating of the digital map conforms to the user-defined map generation constraint.

In some embodiments, the user-defined map generation constraint comprises a user requirement that offline stores on the digital map be within a pre-defined walking distance of each other.

In some embodiments, the user-defined map generation constraint comprises a user requirement that offline stores on the digital map be within a pre-defined driving distance of each other.

In some embodiments, the user-defined map generation constraint comprises a user requirement that offline stores on the digital map be accessible via a particular type of public transportation.

In some embodiments, the user-defined map generation constraint comprises a user requirement that offline stores on the digital map be within a particular single shopping mall.

In some embodiments, the method may comprise: generating a first digital map indicating a first series of offline stores, which correspond to a first batch of online-tagged products that said user selected online; generating a second, different, digital map indicating a second series of offline stores, which correspond to a second batch of online-tagged products that said user selected online

In some embodiments, at least one particular online-tagged product, which user tagged once online, appears in both first digital map and the second digital map.

In some embodiments, the method may comprise: displaying on said digital snap, (A) a name of the first product, in proximity to a first map pin indicating the on-map location of the first location of the first offline store, and (B) a name of the second product, in proximity to a second map pin indicating the map location of the second location of the second offline store.

In some embodiments, the method may comprise: displaying on said digital map, (A) a miniature image of the first product, in proximity to a first map pin indicating the on-map location of the first location of the first offline store, and (B) a miniature image of the second product, in proximity to a second map pin indicating the map location of the second location of the second offline store.

In some embodiments, the method may comprise: generating turn-by-turn navigation directions, directing the user (A) from the current location of the user to the first location of the first offline store, and (B) from the first location of the first offline store to the second location of the second offline store.

In some embodiments, the method may comprise: converting an online browsing of a product at a particular web-site, by said user, into a real-world purchase transaction that is subsequently performed by said user at a real-world store which corresponds to said particular web-site, based on information provided to said user through said electronic device.

In some embodiments, the method may comprise: aggregating and/or storing multiple selections that the user performs online, across multiple websites, into a list of cross-website tagged items; generating and displaying to the user a digital map of real-world stores, which offer for sale at least a subset of said cross-website tagged items, within a user-defined radius around a particular geographic location.

In some embodiments, the method may comprise: aggregating and/or storing multiple selections that the user performs online, across multiple websites, into a list of cross-website tagged items; generating and displaying to the user a digital map of real-world stores, which offer for sale all of said cross-website tagged items, within a user-defined radius around a particular geographic location.

In some embodiments, a user utilizes an electronic device in order to browse an online store and to tag images of products, by selecting such images, or by dragging-and-dropping such images onto a dedicated on-screen toolbar. The tagged images from multiple online stores are stored in a repository, together with data identifying the tagged products, their prices, and the online stores that sell the tagged products. A matching module determines which offline stores sell the tagged products. In response to a user command, a digital map is generated, showing offline stores which sell offline the tagged product and which are located within a user-defined distance from a particular user-defined geographical location.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments of the present invention;

FIG. 2 is a flow-chart of a method, in accordance with some demonstrative embodiments of the present invention;

FIG. 3 is a schematic block diagram illustration of a system, in accordance with some demonstrative embodiments of the present invention;

FIG. 4 is a schematic illustration demonstrating a drag-and-drop tagging operation, accordance with some demonstrative embodiments of the present invention;

FIG. 5 is a schematic illustration demonstrating a collection of tagged online products, in accordance with some demonstrative embodiments of the present invention;

FIG. 6 is a schematic illustration demonstrating adding of tagged products into a planned shopping spree, in accordance with some demonstrative embodiments of the present invention;

FIG. 7 is a schematic illustration demonstrating a generated shopping spree map displayed on a screen of an electronic device, in accordance with some demonstrative embodiments of the present invention; and

FIG. 8 is a schematic illustration demonstrating a collection of tagged items that the user has already purchased, in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it may be understood by persons of ordinary skill in the art that some embodiments may be practiced without these specific details. In other instances, well-known methods, procedures, components, units and/or circuits have not been described in detail so as not to obscure the discussion.

The present invention may comprise devices, systems, and methods of controlling electronic devices via thought, or via analysis or detection of brainwaves or brainwave patterns that correspond to pre-defined or pre-taught patterns.

A user of an electronic device (e.g., a desktop computer, a laptop computer, a smartphone, a tablet, or the like) may often browse or search Internet websites and online stores for various items. The user may find items of interest, and may optionally add such items into a virtual shopping cart. The Applicants have realized that such user may often refrain from completing an online purchase transaction of an item-of-interest, due to one or more reasons.

For example, some users may be concerned about providing payment details over the Internet (even if the communication link is marked as “secure”). Some users may not he sure whether they would like the item that they saw online, or if it will indeed fit them once they actually receive it. Some users may prefer to “touch and feel” the item in an offline store, or may prefer to see the item in real life prior to purchasing it. Some users may not have sufficient time or patience or knowledge to complete an entire online transaction. Some users may be deterred from completing an online purchase by shipping and handling costs, or due to the time that the shipping and handling may require. Some users may be concerned about the possibility and the procedure for returning or exchanging an item purchased online. The Applicants have realized that due to these concerns and/or other concerns or reasons, an item-of-interest may not actually be purchased online by a user who showed interest in that item.

The Applicants have realized that users love to shop; and that shopping provides a thrill of discovery, of finding and of getting what the user wants. E-commerce bias improved shopping, with a world of endless options, on-demand access, style inspiration, and user-targeted offers. The Applicants have realized that there is a large gap between online browsing of items and actual online sales. For example, while many users may research online, only a portion of such users actually buy items online. Users may find online items that they like, but such “finding” often does not translate into an online purchase. For example, some users may want to touch, feel and try the item in real-life prior to purchasing it, thereby making some of their purchases in offline stores.

Despite the benefits of online shopping (e.g., great selection to choose front; options for rapid shipping or free shipping), tactile experience remains critical to conversion of browsing into actual sales. In accordance with the present invention, the “Hunt” or “Go Hunt” solution or interface or application may translate or convert online browsing behavior into in-store purchase.

The present invention may comprise systems and methods allowing conversion of such unfinished online transaction, or an identified user interest in an online item, into a real-life sale transaction of that item to that user, in a real-life brick-and-mortar store which sells that item.

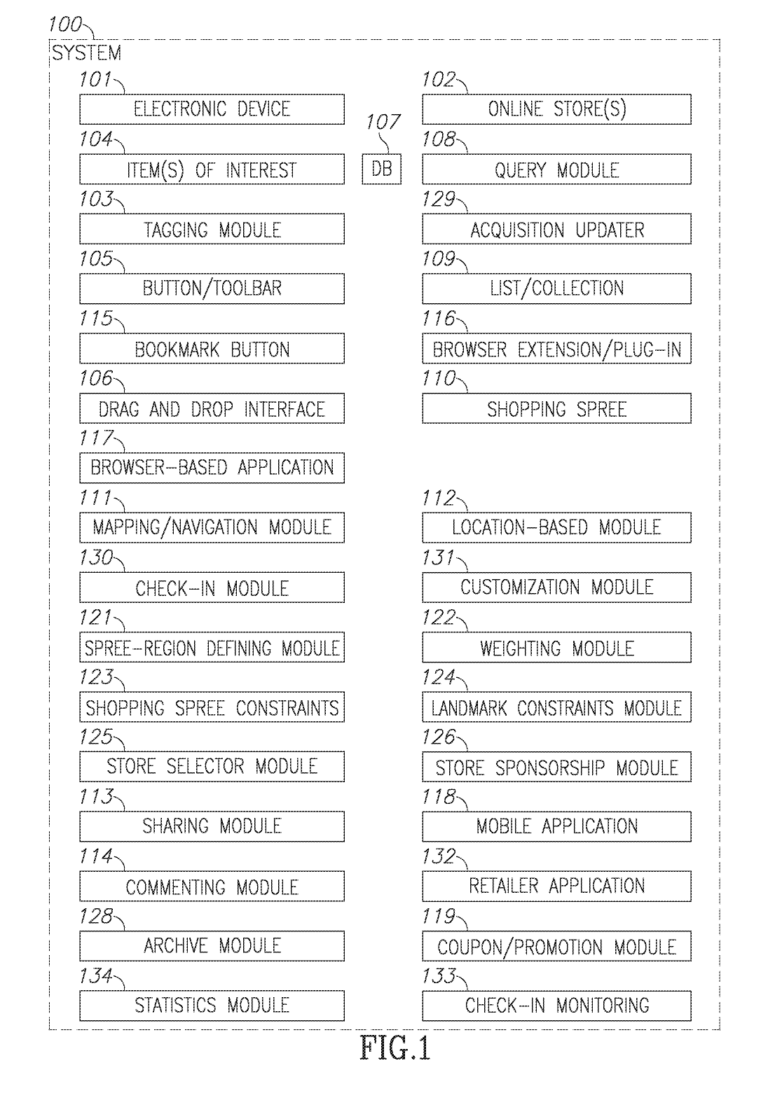

Reference is made to FIG. 1, which is a schematic block-diagram illustration of a system 100 in accordance with some demonstrative embodiments of the present invention. A user may utilize an electronic device 101 to browse one or more online store(s) 102 for items-of-interest. The user may utilize a tagging module 103 to mark or tag online an item-of-interest 104, for example, by clicking on (or using) a “hunt” or “get hunt” or “go hunt” button/toolbar 105, or by utilizing a drag-and-drop interface 106 for dragging an image of the item-of-interest 104 onto such “go hunt” button 105 (or region, or toolbar, or other interface component). Items that were marked by the user may be stored in an online or remote or cloud-based database 107, together with their description, price, time/date stamp of browsing and/or tagging, and identification of the particular online vendor or website in which the item-of-interest was viewed and marked.

At a later time, the user may utilize a query module 108 to request to view collection or list 109 of previously-marked items-of-interest of that user, when the user visits the relevant offline premises (e.g., the user had marked a Gap shirt while browsing online, and later he can see and touch the item that he marked in a real-life Gap store). The list 109 may be shown to the user, showing previously-tagged items-of-interests from multiple, different, online stores, or from the particular store that the user is currently visiting or intends to visit soon.

The user may request a “shopping spree map/trail” generator 110 to generate a “shopping spree trail” or “shopping spree map” (optionally including turn-by-turn route guidance or navigation steps), to allow the user to visit real-life stores corresponding to all or some of the previously-marked items-of-interest. By utilizing a mapping/navigation module 111, as well as a location-based module 112 able to dynamically determine the current location of the user, system 100 may determine or detect the geographic location of the user, and may suggest to the user nearest store(s) that sell one or more of the items-of-interest previously marked as such on the user's list 109. System 100 may thus generate a suggested path or route or trail, advising the user to visit firstly a first particular offline store in order to purchase there a first subset of the items-of-interest from list 109; to then proceed to a second, different, offline store in order to purchase there a second subset of the items-of-interest from list 109; and so forth. Optionally, the list 109 of items-of-interest of a user, and/or a suggested “shopping spree trail” generated by generator 110, may be shared by the user via a sharing module 113 with friends, allowing such other users to utilize a commenting module 114 to comment on the items-of-interest and/or on the suggested shopping spree trail.

Portions of the discussion herein may relate, for demonstrative purposes, to tagging or “hunting” of online items that are available for online purchase, in order to later generate a. shopping spree region and/or path to allow the user to view and purchase the “hunted” items offline in real-life (brick-and-mortar) stores. However, the present invention may include other types or goals of online marking (hunting) for subsequent offline usage; for example, a tourist may plan on visiting a particular city, and mark online (hunt) particular landmarks or tourist attractions or destinations, and may later request a spree or route which includes visits to some or all of these landmarks, optionally providing the user with coupons or promotional offers related to those landmarks (or to business entities near such landmarks).

System 100 may be utilized as a smart shopping tool, allowing users to manage what they find online; to plan their shopping trip and find out what their friends think about a planned shopping trip; to access personal offers and service in-store, and to capture what they are looking for.

For retailers, vendors, and stores (particularly retailers that have both an online shopping website and an offline store), the Hunt system may provide a sales conversion tool, allowing the retailer: (a) to know what the users want, and help them get it; (b) to offer targeted deals to drive traffic into real-life stores and to increase in-store discovery of items; (c) to personalize service, and empower inventory planning; and (d) to increase Return On Investment (ROI) of online marketing and in-store promotions.

The present invention may provide an easy-to-use system, for retail marketing managers or POS installations. The user-friendly CMS system may provide, for example: Demographic and style-profile analytics; Data analytics on “hunted” (marked, tagged) items; Check-in notification for in-store servicing; Real time promotion management; Performance and conversion metrics.

In some embodiments, system 100 may further comprise, for example: (a) a Bookmark button 115, which may be a button (or link, or other interface component) that the user places or sees on (or near) the Web browser (e.g., on or near the bookmark bar or other toolbar or area); and which may be pressed or clicked or selected, every time the user wants to collect or mark or tag an item presented in a Web page; (b) a Web browser extension/plug-in 116 or extension, for example, in the form of a banner appearing at the bottom of the web page, implementing one or more of the features of the present invention (e.g., drag-and-drop capability of items thereon); (c) a Web-based or browser-based application 117 for managing the collected or bookmarked items and later requesting to generate shopping spree routes for purchasing in offline stores all or some of the collected items that are in the list 109; (d) a Mobile application 118 which may be used while shopping offline, to view items in the collection list 109 that are relevant to the current offline premises that is being visited by the user, to navigate to such offline store, and to receive or accept retail offers once in the offline retailer premises via an integrated Coupon/Promotion Module 119; (e) a Retailer application 132, which may be a web-based or browser-based application used by the retailer or vendor, to upload or configure or define offers per their prospect customers “hunt” (item tagging) statistics, as well as general offers to be redeemed once the consumers are within the offline store.

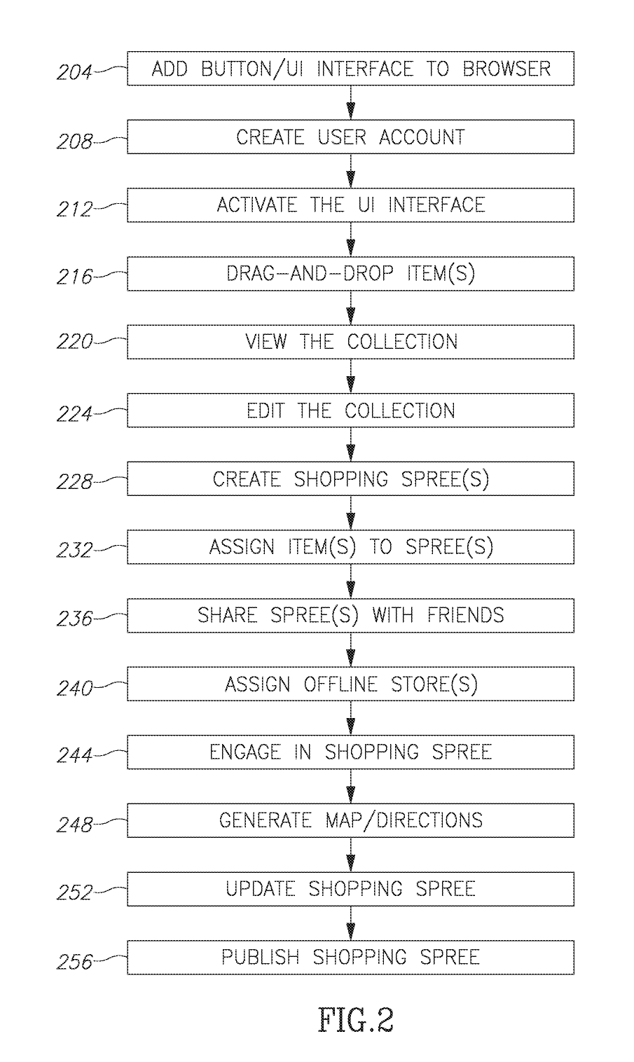

Reference is made to FIG. 2, which is a flow-chart of a method in accordance with some demonstrative embodiments of the present invention. The method may be implemented, for example, by system 100 of FIG. 1, by device 101 (e.g., a smartphone, a tablet, a personal computer, a laptop computer), or by other suitable device or system.

Initially, the user may install or add the “Hunt” or “Go Hunt” or “Hunt It” button (or toolbar, or user interface) to his browser (block 204), at the bookmark bar or in other suitable location or region of the user interface. This may be a button used for collecting (or ‘hunting’, tagging, marking, keeping) various items reviewed during web browsing via a web browser. Optionally, the Hunt button may be embedded. in the browser, may be a plug-in or add-on or browser extension, may be an external application or window, may be built-in within the web browser, may be running as a separate window or layer or application, or may otherwise be installed or accessed by the user.

The user may create an account (block 208) to serve as a context to his/her collected items. Account creation may be done using email/password or through an existing Facebook/Twitter/Google/Microsoft account (or other suitable social network account). The user may open or access the account immediately after adding the Hunt button to his browser, or once the user starts the actual “hunting” activity (gathering of items from ordinary web browsing for later retrieval).

Once the Hunt button is available and appears (e.g., on the bookmark bar the user may start the hunting activity by pressing the Hunt button to activate the “hunt” footer (block 212) at the bottom of the browser (or as a header at the top of the browser; or ad a side-toolbar on the right side or left side). The Hunt footer may appear on top of the current browsed web page (or, may cause the browser window to slightly resize or shrink and make room for the Hunt footer or region).

The hunt footer or toolbar or button may enable the user to drag an item thereon (block 216), for example, by dragging an image of an article, offered for sale on a website, or any other item or location of interest, onto the Hunt footer region. If the user does not have an account and is not logged it, the user may be asked to create an account and to log-in prior to collection of items, or upon an attempt to collect a first item. Optionally, the Hunt footer or bar may “drop” to the bottom of the web page after an item was dragged to it, to enable a smooth and unobstructed web browsing; and in such case, the Hunt bar or footer may rise or raise again once the user hovers on it or drags a new item to its location.

Once the user has collected items, he may vie the collection online (block 220), and may optionally edit the collection (block 224) by removing items, changing the order of items, sorting or filtering items by criteria (e.g., by price, by type of item), adding a personal comment to an item, or the like.

The user may generate one or more shopping spree trails (block 228). This may be done via Hunt's web-based application (e.g., where the user may be taken after selecting the “preview all items” link at the bottom of the Hunt It footer or toolbar). A shopping spree trail or path may be a planned shopping tour or event or route or path, that may optionally have a definite theme or place or any other context (e.g., shopping with morn) and/or a definite geographic area or shopping mall (e.g., center of London, Upper East side in Manhattan, or Cherry Hill mall). The user may ask the system to generate or create shopping spree(s), and may optionally edit them manually, such as, by naming them per the relevant theme to them, or defining the area(s) for each such shopping spree.

The user may selectively assign item(s) to shopping sprees (block 232) that were generated (e.g., by drag-and-drop operations, or by tagging or marking items to be associated with a particular spree). In some embodiments of the present invention, an item may optionally be included in two or more shopping sprees; for example, a raincoat item may be part of “Shopping Spree with mom”, of “Winter Clothes shopping spree” and of “Cherry Hill Mall shopping spree”.

The user may share with friends (block 236) selected item(s), or all the items, in the collection, or may share with friends entire spree(s). The user may also mark a collected item as a favorite or preferred; and may optionally obtain additional information on selected items (e.g., user ratings, user reviews). Optionally, friends may provide comments to the user with regard to collected items and/or with regard to an entire shopping spree that the user planned.

The system may then assign an offline store for each item on the shopping spree (block 240), automatically and/or manually. If a hunted item has no store allocated to it, then the user may be asked to set such a store (e.g., prior to adding the item to the spree, or during that adding operation). The system may know to automatically associate or link between items viewed online, and offline stores that sell those items. For example, if the user “hunted” an item on the website “Gap.com”, the system may determine that the item may be purchased offline at stores of the retailer “Gap”. A lookup table or directory, or contextual analysis or textual analysis or URL analysis, may be used in order to correlate or link between online vendors and their corresponding offline stores, or vice versa.

Once a shopping spree is finalized, the user may request to engage in the shopping spree (block 244), which may cause the system to provide to the user a digital map (block 248) with step-by-step (or turn-by-turn) instructions or navigation instructions or directions, guiding the user how to reach the first node on the shopping spree, then the second node, and so forth.

Optionally, at each node along the shopping spree, the user may indicate to the application or to the system, that the “hunted” item has been purchased; or alternatively, that the “hunted” item is skipped or saved-for-later, or is being deleted or omitted from the shopping spree, or other dynamic modification of hunted items due to real-life shopping spree updates (block 252).

Optionally, at the end of the shopping spree or prior to its ending, the user may publish to friends or to social media or to other recipients, an automatic update with regard to the progress and/or the results of the shopping spree (block 256), for example, indicating to the recipients where and when the user has visited, and which “hunted” items were purchased or skipped.

Referring again to FIG. 1, the user may create a shopping spree via designated links appearing on a Collection web page. The user may give the spree a name, assigns an identification color to it, and may indicate the region or the geographical area of the spree (e.g., using a street address, or a city or district, or a geographic landmark, for example, “Garden State Plaza Mall”). If the user indicates a region or city, then the city center (or region center) may be considered the center of the spree area. The radius of the spree may be a predefined value, and may be changed or selected by the user.

If the Hunt application does not automatically recognize the brand/store of a hunted item while attempting to map it, then the system may ask the user for this information. The user may also change this information on-the-fly.

A spree may have a definite default radius set by a default attribute that can be overdriven or changed by the user. A spree it presented on a map, has location characteristics and has a list of collectable items associated with it. In cases where the items set for the spree are outside of this radius, the system may notify that to the user by stating that these items are outside of the spree boundaries. The user may have the option to exclude those items from the Spree, or to increase or change the boundary or radius of the spree, or to request from the system to generate an enlarged-area spree that will include also those items.

For demonstrative purposes, the Spree Area is described herein as circular area defined by a radius around a center point. However, some embodiments may utilize a spree area which may be non-rectangular; for example, may be defined as rectangular (for example, in Manhattan, between 14th street to 23rd street, and between 5th avenue to 7th Avenue), or may be defined by selecting one or more neighborhoods (e.g., Chelsea in Manhattan), or may be defined by a particular means of transportation. (e.g., a spree that includes stores that are up to 500 yards away from the 6 line of the Subway train; a spree that includes stores that are up to 300 yards away from the M42 bus) or may be defined by particular geographic constraints or environmental constraints (e.g., a spree that includes only stores within a particular shopping mall).

In some embodiments, the user may be able to draw a circumference or contour or boundary of a spree by freely dragging a pointer or by drawing over a touch-screen showing a map, and the spree region may be defined to correspond to the area within the boundary drawn by the user on the map.

In some embodiments, a use may select a previously-selected or previously-used spree region, that was previously defined by the user or by the system for the purposes of a previous shopping spree (e.g., allowing the user to replicate a region for “winter shopping spree” based on a previous region of a “summer shopping spree”).

In some embodiments, the system may calculate or determine the best region or a suitable region for the spree, and may suggest to the user one or more regions that may be included in the shopping spree; for example, the system may detect that the user is hunting for “Crocs sandals”, and may suggest a spree region that includes at least one store which sells that particular product.

In some embodiments, the user may request from the system to generate a shopping spree that will include at least a certain percentage of the hunted items (e.g., at least 80 percent), and/or that will encompass a geographical region not greater than a threshold size (e.g., up to one square kilometer, or up to six street-blocks by three avenue-blocks). Other suitable parameters may be used to define a geographical region of a spree, through a suitable spree region-defining module 121.

In some embodiments, the user may indicate that a particular “Hunted” (tagged) item is mandatory to be included in a shopping spree, or is optional for inclusion in a shopping spree, and the system may take these indications into account when generating suggestions for shopping spree region and/or route.

In some embodiments, the user may optionally use a weighting module 122 to assign to each Hunted item a “weight” or a relative weight or an “importance” indicator (e.g., on a scale of 1 to 10, or on a scale of “must have” through “nice to have” to “not really necessary”). When generating a shopping spree region or path, the system may adapt by necessarily including the Hunted items that were marked by the user as “must have” items that must be included, whereas other Hunted items that were marked as “nice to have” or “not really needed” may be excluded (e.g., in order to meet other spree-determining constraints, such as region size).

In some embodiments, a spree region or route may be generated such that it includes the maximum combined. “weight” assigned to various Hunted items, out of a collection of Hunted items.

he some embodiments, the user may define one or more shopping spree constraints 123 on determining a shopping spree region or route, for example: define a shopping spree route that avoids taking public transportation; define a shopping spree route that avoids paying road-tolls; define a shopping spree route that allows free parking (or, paid parking) for vehicles; define a shopping spree route that excludes shopping malls in general, or that excludes a particular shopping mall (or a particular store); define a shopping spree route that avoids highways, or that avoids one-lane streets; define a shopping spree route that includes, or that excludes, a certain type of stores (e.g., department stores such as Macy's; or low-budget retailers such as Walmart or Kmart); define a shopping spree route that includes, or that excludes, stores that have certain size (e.g., exclude any store that is smaller than 500 square-feet; exclude any store that is larger than 20,000 square feet); define a shopping spree route that meets certain accessibility requirements (e.g., exclude stores that are not fully accessible to disabled people; exclude stores that have internal stairs or an escalator but not an elevator; exclude stores that do not allow animals; include stores that allow animals); or other suitable constraints for defining a shopping spree region and/or route.

Optionally, and particularly if the user is visiting a city as a tourist or for short-term, the user may define that the shopping spree region or route may include, for example, one or more particular landmarks (e.g., the Empire State Building) or may include stores in proximity to such landmark(s); may include or may be near one or more activities performed by tourists (e.g., attending a Broadway show); may include, or may exclude, areas or stores that are known to be popular among tourists or that may be next to tourist attractions; or the like. Such requirements may be defined and/or enforced by utilizing a landmark constraint module 124.

In some embodiments, the Hunt system administrator may have a particular arrangement with one or more retailers or vendors or merchants or advertisers or business entities, in order to emphasize or promote their stores when determining a shopping spree, or even in order to replace a first store with a second store which pays a commission or an advertising fee to the Hunt system administrator. In an example, the user may “hunt” for a Sony television of a particular model; a shopping spree may include either the Best Buy store or the PC Richards store next to it; vet the Hunt system may choose to include one of those stores (and to exclude the other stores) because the store to be included has paid to the Hunt operator an “inclusion fee” or a “preference fee” or a “sponsor fee”; a disclosure about this may or may not be presented to the user. This may be performed by a store selector module 125, which may optionally be associated with a store sponsorship module 126.

The user may review the defined spree in the web application screen through a srnartphone or tablet or mobile application). The user may see how the stores of the hunted items are presenting as a layout over a geographical map, using the spree mapping/navigation module 111. By clicking on a stop in the spree, the user may also see, in small thumbnails, the hunted items that are allocated as available for purchase in each such store.

In addition to the Collection view, the user may see in the Offer view the current available offers from the stores s/he has hunted items in. The offers may include, for example, a coupon which may be displayed on the user's mobile device and then scanned by a barcode reader at the offline store in order to obtain a discount (e.g., 20 percent off) or a promotional item (e.g., get a free bag with purchase of over 30 Dollars).

Hunted items may optionally be associated with a predefined expiration date (that the user may optionally be able to change, and/or that the retailer may optionally be able to change or to extend). Once an item was hunted, the user can map it to a spree and/or see it in a spree for a pre-defined period (e.g., thirty days). When the period ends, the items on that spree may be archived for later retrieval by an archive module 128, and the user may view them in a designated section that the application may provide. In some embodiments, the user may designate an “infinite” expiration date or no expiration date, to indicate that an item may remain Hunted indefinitely or for a very long period of time (e.g., ten years) until manually removed or un-tagged by the user.

The application may also provide view of the purchased item(s). A user may mark an item as purchased either by hovering it in the web application (collection view) or by marking it purchased in the mobile app, or by performing other suitable operation (e.g., click, tag, un-tag, or the like). If an interface exists between the Hunt application and the relevant store, Hunted items may be marked as purchased automatically upon the purchase action at the offline store, thereby updating in real-time the collection of Hunted items to indicate that a particular item has just been purchased. Optionally, by using an acquisition updater module 129, an acquisition of a Hunted item, may automatically cause removal of that item from one or more other shopping spree(s) that may be available for that user (for example, a purchase of the umbrella during the shopping spree of “shopping with mom”, may also cause automatic removal of that umbrella from the shopping spree of “winter shopping” of that user).

After downloading the Hunt mobile application (e.g., a one-time activity), and initial login to the system, the user (e.g., a registered user, if not then user may be asked to create an account) may be presented with the available shopping sprees.

The user may choose to embark on a planned spree, or may choose to shop “on the go”. Upon the selection of a spree, a map of the relevant area is presented to the user together with the stores that take place in the spree (e.g., the stores that the user hunted their items to purchase/examine in real-life). If the user does not wish to embark on a specific spree s/he may choose to shop “on the go”; and in such case the user may be presented with the relevant stores and business entities around (where the user has mapped items to stores).

Once the user selected a spree, he is presented with the map of the area that he is in, and the relevant stores (e.g., stores having items that the user stated that s/he is interested in, by marking them as “hunted”). By pulling a screen pane from the bottom of the screen, the user may see the details of the stores or premises that are part of the shopping spree. The sprees may be sorted by their distance from the current location of the user, or may be sorted or filtered by other parameters which may be selected by the user (e.g., sort the sprees based on the number of items in each spree; shop the spree based on the cumulative price of the items in each spree; sort the sprees based on the date of adding the most-recent item in each spree; or the like). The user may also request to see more details about each store, for example, to see offers that the premises currently have for the user, and to see a list of hunted items by the user in each store or premises). The location of the user may be clearly marked on the map (e.g., with a purple dot, or star, or flag, or a push-pin, or the like) for the use to see his location relative to the stores.

The user may then decide when s/he would like to go, and select the destination store by pressing the store/premise identifier on the map. The user may then be presented with a pop-up window presenting the exact address of the target destination (store/premise) and the distance to it. The user may view the offer and hunted items related to that destination. By pressing the “take me there” link or button, the user may obtain directions or route-guidance information towards that destination.

Once the user selects “Take me there”, he may be asked whether he wishes to travel by car, by foot, by taxi, by using public transportation, or the like. The Hunt system may use a mapping system, navigation system, route guidance system, or other suitable mapping modules or navigation modules (e.g., Google Maps, Google Earth, MapQuest, or other services, optionally accessible to the Hunt system via an API).

Once the user arrives to the store, s/he may use a check-in module 130 to perform check-in to see the items that were hunted for at that store, as well as offers and special check-in offers. These offers may be general (e.g., to all customers), and/or personalized offers from a user-specific customization module 131 per the user profile and hunted items.

Once the user checked-in at the store, s/he may be presented with the hunted items and offers from that particular store. The user can view these items, for example, by browsing his/her hunted store collection, or by filtering the specific store collection. The user may change the collection or mark items as purchased by selecting the Edit button on the right upper corner. The user may mark all the collection items (or selectively, some of them), mark them as purchased, or remove them from the collection.

Through the menu window, the user may see the current available offers, the items that were purchased, and the overall collection of the hunted items.

Upon the selection of ‘Offers’ from the mobile menu, the current offers may be presented to the user. The user may choose to see them or sort them or filter them, for example, by store, by expiration date, or by spree (e.g., offrs available in a specific spree). Other suitable parameters may be used. The user may view the purchased items by selecting the Purchased link in the menu screen.

Optionally, a retailer web application 132 may be used by retailers to generate and view Hunt-related statistics, and to communicate with the Hunt users by offering them general and/or personalized offers. After subscribing to Hunt, retailers may upload offers (general and/or specific to certain types of customers or products). General offers may be viewed as store offers when viewing them via the mobile application of the user. In case a general offer applies to a hunted item, such offer may appear in the offers view of the web application. Optionally, a specific offer may be applied to Hunted items only.

Through the retailer web application 132, the retailer may view the list of current and expired offers. In addition to uploading and viewing the offers details, the retailer may view statistics on current running offers and users check-in to particular stores or branches, which may be monitored by check-in monitoring module 133, and may be processed by statistics module 134, for example, how many items were tagged per day; how many users tagged items per day; how many users who tagged have also check-in; most “hunted” or tagged items; most checked-in locations; gender or age characteristics of “hunting” users) The retailer screens may originally be generic, and may be configured or tailored per the agreement between the Hunt system operator and each retailer. In some implementations, a retailer may use the Hunt system “out of the box” and join the Hunt network via the Internet without necessarily negotiating a specific contract, and may then utilize a generic retailer web application (or alternatively, later, a retailer-specific application tailored to his particular needs or industry).

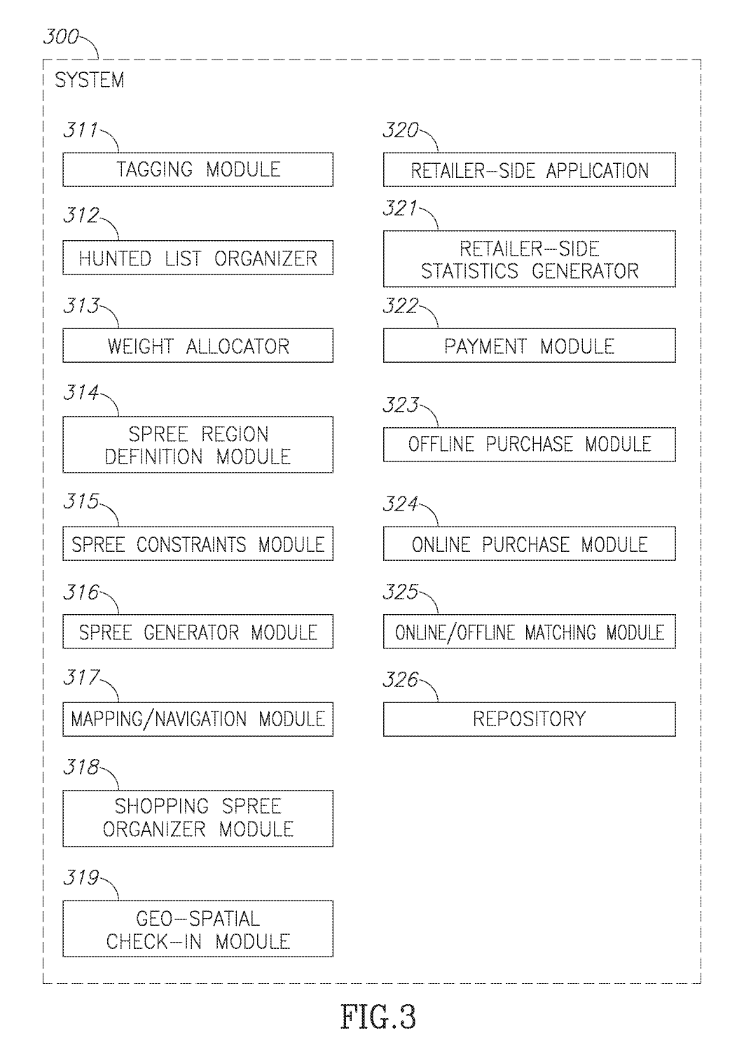

Reference is made to FIG. 3, which is a schematic block diagram illustration of a system 300 in accordance with some demonstrative embodiments of the present invention. System 300 may be a demonstrative implementation of system 100 described above.

System 300 may comprise, for example, a tagging module 311, a hunted list organizer 312., a weight allocator 313, a spree region definition module 314, a spree constraints module 315, :spree generator module 316, a mapping/navigation module 317, a shopping spree organizer module 318, a geo-spatial check-in module 319, a retailer-side application 320, a retailer-side statistics generator 321, a payment module 322, an offline purchase module 323, an online purchase module 324, an online/offline matching module 325, a repository 326, and/or other suitable hardware components and/or software modules.

Tagging module 311 may comprise a marking module, allowing a user to browse online products and to selectively mark or tag an online item as “hunted”. Optionally, a drag-and-drop interface may be used, to allow a user to drag-and-drop an image of an item from an online web-page into or onto a toolbar or button. Optionally, an “add one” symbol or image may be displayed or overlaid or super-imposed on top of image(s) of items online, thereby allowing the user to click or, or choose, items whose images may not be dragged-and-dropped onto such toolbar or button.

The tagging operation of the user may cause the system to update or to create a record in a repository 326 which stores tagged products and their corresponding data, for example, product name, product ID or product identification, product SKU number or model number, product image, price, the name and URL of the online store or web-page in which the product was tagged, and other product-related data and/or merchant-related data. The repository 326 may be associated with various control modules, for example, an editor module, a search module, a sorting module, a filtering module, a record updating module, a record creation module, a record deletion module, or the like.

Optionally, the tagging operation of a product online, may be accompanied by automatic capturing and saving of a screen-shot of the web-page in which the product was tagged; and optionally allowing the user to crop or edit the captured screenshot, which may later be retrieved in order to help the user remember additional details about the tagged item, or in order to allow the user to crop a particular portion or area of the captured image (for example, the online image may show both a shirt and pants, and the user may crop to keep only the shirt for subsequent retrieval).

Hunted list organizer 312 may allow the user to view hunted (tagged) items, sort them, search them, filter them, edit them, remove or delete hunted items, or share hunted items with friends; as well as add them to one or more planned shopping sprees.

Weight allocator 313 may optionally allow the user to allocate a weight or a level-of-importance to hunted items e.g., “must have” or “not really sure”).

Spree region definition module 314 may allow the user to define geographical constraints to the shopping spree region and/or route.

Spree constraints module 315 may allow the user to define other constraints to the shopping spree region and/or route (e.g., exclude shopping malls; include only shopping malls; include only pet-friendly stores; include only shops that accept a particular credit card; include only stores that are open on Sunday, or that are open between 7 PM to 8 PM).

Spree generator module 316 may generate one or more suggested shopping spree routes, based on some or all of the hunted items, and by taking into account the geographical constraints and/or other constraints defined by the user. The spree generator module 316 may utilize an online/offline matching module 325, able to match between (a) an online product tagged online in an online store, and (b) an offline store (or, a particular branch of an offline store) which sells that product, or which is associated with or affiliated with that online store. For example, the user may tag a shirt online, on the website “Gap.com”; and the online/offline matching module 325 may determine (for example, based on the URL of the web-page in which the image was tagged, or based on other data or meta-data, or based on contextual analysis) that a real-life store of “The Gap” corresponds to that online store. It is noted that some embodiments may not generate a step-by-step plan of how to navigate from one store to another store; but rather, may display to the user a plurality of stores shown as “map pins” on a map, allowing the user to choose the stores that he wants to visit.

Mapping/navigation module 317 (or route-guidance module) may generate and provide to the user directions and/or route guidance from the user's current geo-spatial location to one or more destinations on the shopping spree in order to try and/or buy “hunted” (pre-tagged online) items in real-life stores.

Shopping spree organizer module 318 allows the user view or edit shopping sprees, to sort them, filter them, delete them, create new ones, share them with friends, archive them, publish them to a social network or a blog or to the Internet, export or import shopping spree data through a suitable data format (e.g., XML, or CSV), add or remove constraints or requirements from shopping sprees, or the like.

Geo-spatial check-in module 319 may allow the use to perform a “check in” operation at an offline store, to indicate to the Hunt system and/or to the retailer that the particular user has arrived to that particular offline store. The check-in may be, for example, a scanning or imaging of a check-in barcode or two-dimensional bar-code or QR code; or may be implemented as a “virtual check-in”, for example, allowing the user to click or tap on an on-screen button indicating “I am here?” or “I arrived!” in relation to a particular store which appears on the list or on the map. Based on the check-in, the Hunt mobile application may show to the user, the specific pre-tagged (hunted) items that are available for offline purchase at this retail store. Optionally, the system may automatically determine that the user is located at, or within, or near, a particular offline store that is a node on the shopping spree map; for example, based on GPS data, based on Wi-Fi or wireless communication network(s) accessible from such location (e.g., identifying an accessible wireless network SSID named “TheGapStore”), or the like.

Retailer-side application 320 allows the retailer to selectively define offers. promotions coupons and/or discounts to general customers, to “hunting” customers that checked in, to “hunted” items that are being viewed offline by a hunting customer, or the like.

Retailer-side statistics generator 321 allows the retailer to obtain data and statistics regarding “hunted” items and/or “hunting” customers, in real-time and/or in retrospect (hunting history); and allowing the retailer to obtain Conversion Data, for example, calculating that 45 percent of customers that “hunted” online for Gap.com items in the past 7 days have “converted” into at least one purchase in offline Gap stores (or, in a particular offline Gap store); calculating that on average, each hunting customer has purchased at least two of the hunted items in an offline store in the past 30 days; calculating data that is specific to a particular type of merchandise (e.g., data about converted hunted items that are for females, or for males, or for children; data about converted hunted items that are for the winter season); data about the average or mean price of converted hunted items; or other types of statistics; data about the offer(s) that e used the most, or that were use the least; or the like.

Payment module 322 may optionally allow automatic or periodical payment of commission or fees from the retailer to the Hunt system operator, for monthly or yearly subscription fees or operational fees, or for commissions from the sale of hunted items to hunting customers.

Offline purchase module 323 may allow the use to “close the loop” and to inform the system that he user has purchased offline, in a real-life store, one of the previously-“hunted” (tagged) items. This may trigger, for example, removal of the purchased items from current of subsequent shopping sprees, or from the list of hunted items waiting to he purchased; may cause movement of the purchased item to a “my purchased items” collection or folder; may cause suggesting to the user to share with his friends that he purchased the item, or the like.

Online purchase module 324 may allow the user to “close the loop” by consuming an online purchase rather than an offline purchase. For example, the user may hunt (tag) an item online; may later visit an offline retail store to inspect the actual item; but may then decide that the user prefers to purchase the item online (e.g., due to price or tax considerations; or if the item is bulky and the user prefers that the item would be shipped to the user's home; or if the user does not wish to carry the item with him for the rest of the day until the user arrives home). The user may thus launch the smartphone application of the Hunt system, may view the collection of previously-tagged (hunted) items; and may select one or more items for online purchase.

In son-me embodiments, the Hunt system may be used as an intermediary element in a purchase transaction. For example, the user may browse online and may “hunt” a jacket; may then see the jacket at an offline store; and may then purchase the item online. In such case, the Hunt system may track and recognize the three stages of interaction by the same user across the three stages, both online and offline, and may optionally require the retailer to pay a commission or a fee to the Hunt system operator for facilitating that purchase, even though the actual purchase took place online and not offline.

In some embodiments, the Hunt system may automatically recognize that a hunting user is entering a particular store (e.g., based on a location-based module and/or based on GPS positioning data or Wi-Fi data or cellular data), and may automatically alert a salesperson at that store to the fact that a hunting customer entered the store. Optionally, the hunting list of that customer may be shared by the Hunt system with the salesperson, such that the salesperson may approach the relevant store section (e.g., children's clothes) to assist customers that may be hunting there. Optionally, or with the user's consent, the Hunt system may provide to the salesperson one or more details of the hunting customer (e.g., taken from the user profile, or from the social network profile of the customer), allowing the salesperson to more easily identify in real-life the hunting customer within the store (e.g., female, age 34, or the like). Optionally, if the hunting user is associated with a social network account or page, then the Hunt system may share with the retailer's salesperson a photograph of the customer (e.g., taken from his public profile on the social network), thereby allowing the salesperson to identify the hunting customer and to approach her or him for particular assistance.

In some embodiments, tagging (hunting) of online items may be performed on a first electronic device (e.g., a laptop, a PC, a smartphone, a tablet), when the user is logged-in to a Hunt system account. Subsequently, when the user wishes to embark on a shopping spree, the user may utilize a Hunt application on a portable device (e.g., stand-alone application or “app”, or web-based application), may log-in to his Hunt account (which may remain logged-in for a pre-defined period of time, or until actively logged out by the user), and may command the system to display on the portable device a map of the shopping spree for hunted items, as well as turn-by-turn navigation instructions among the various nodes or stops or stores that participate in this shopping spree, starting from the user's current geo-spatial location.

In some embodiments, the user may capture through a camera of his smartphone or tablet, a user-specific authentication QR code or two-dimensional barcode, displayed to the user on the screen of a laptop or a computer, in order to perform “pairing” or in order to automatically log-in the user in the smartphone application, thereby saving the user the need to manually log-in on his smartphone application in order to access his Hunt system account from his smartphone. The user-specific QR code or two-dimensional barcode, displayed on the screen of the laptop or computer, may encode therein data indicating the username and the password of the user; and such data may be extracted by the smartphone (after the imaging of the QR code) and may be used by the smartphone to automatically log-in the user into his Hunt account.

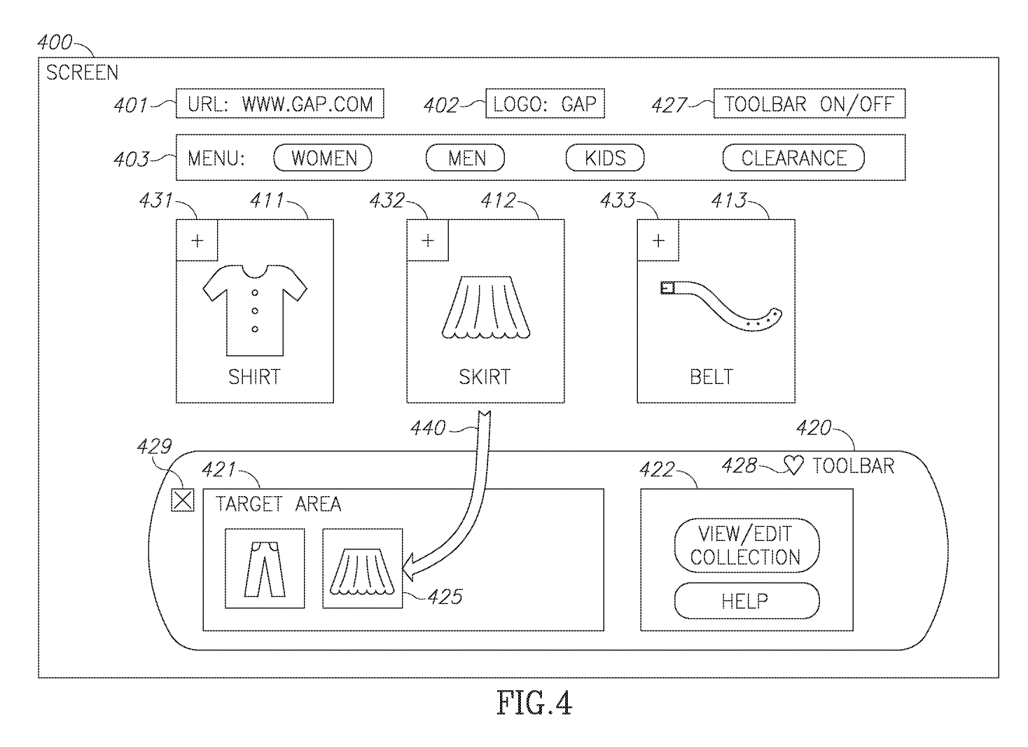

Reference is made to FIG. 4, which is a schematic illustration demonstrating a drag-and-drop tagging operation, in accordance with some demonstrative embodiments of the present invention. For example, a screen 400 of a laptop or personal computer may display a web-page of an online store, including its URL 401, its logo 402, a menu 403, and product images 411-413 (e.g., typically accompanied by textual product description, product price, and optionally other data).

An on-screen toolbar 420 may be presented, superimposed or overlaid on top of a margin of the screen. The on-screen toolbar 420 may comprise a target area 421 for dragging images thereto, and one or more buttons 422 to allow the user to access additional features (e.g., to view or edit the list of previously-tagged products; to define or generate a shopping spree map; or the like). Optionally, a toolbar open/close button 429 may be used to show or hide (or, open/close) the on-screen toolbar 420. Optionally, a toolbar on/off button 427 (or a toolbar show/hide button) may be used to open or close (or, to show or hide) the toolbar; and such on/off button 427 may be located, for example, near the URL area or within the browser area (and not within the web-page itself), such as, as part of the browser extension or plug-in. Optionally, the toolbar open/close button 429 may be implemented as a symbol or image (e.g., a bird image) which may be associated with the system of the present invention. In some implementations, items from the web-page (e.g., an image of a product) may optionally be dragged onto such image or button or symbol, and such dragging may, in some embodiments, cause the automatic opening of the toolbar 420, and/or the automatic adding of the dragged item to the collection of tagged items.

Optionally, a Hunt-friendly symbol 428 (e.g., a heart symbol) may be used to indicate whether or not a particular website is endorsed by the system or is particularly compatible with the system; for example, if the heart symbol is shown or is highlighted, this may indicate to the user that the web-site currently being browsed is endorsed by or approved by the system administrator, or is considered a system-friendly or system-compatible website or a recommended website or trusted website.

As demonstrated by an arrow 440, the user may perform a drag-and-drop movement of product image 411 onto the target area 421 of toolbar 420. As a result, the repository of the system is updated with the data of the tagged product; and the target area 421 may show a scaled-down version 425 (e.g., thumbnail version) of the tagged product image 411.

Additionally or alternatively, product images 411-413 may optionally comprise an additional symbol or image superimposed or overlaid on a portion thereof, for example, the corresponding tagging buttons 431, 432, 433 located at the top-left corner of each product image 411, 412, 413. Pressing or tapping a tagging button 431, may cause selection or tagging of the corresponding product image 411, and so forth; and may similarly cause updating of the repository to reflect the tagging of that product.

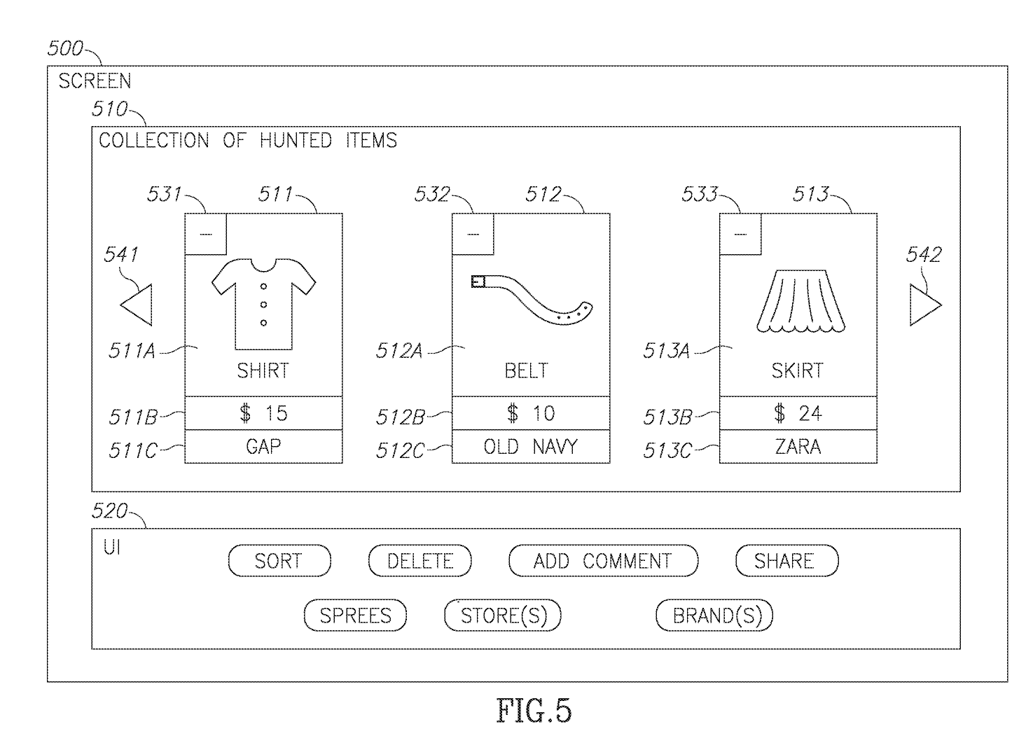

Reference is made to FIG. 5, which is a schematic illustration demonstrating a collection of tagged (“hunted”) online products, in accordance with some demonstrative embodiments of the present invention. A screen 500 of an electronic device (e.g., a laptop, a personal computer, a smartphone, a tablet) may show multiple tagged products in accordance with a desired presentation format (e.g., a list, a table, a matrix or array) and/or in accordance with desired ordering (e.g., chronological order of tagging; sorted by price).

In a demonstrative collection 510, three tagged products 511-513 are shown. The first tagged product 511 may be a shirt, showing an image 511A of the tagged shirt, the price 511B of the tagged shirt, and the store 511C (e.g., the online store and/or the offline store) associated with the tagged shirt.

Similarly, the second tagged product 512 may be a belt, showing an image 512A of the tagged belt, the price 512B of the tagged belt, and the store 512C associated with the tagged belt.

Similarly, the third tagged product 513 may be a skirt, showing an image 513A of the tagged skirt, the price 513B of the tagged skirt, and the store 513C associated with the tagged skirt.

Further depicted are User Interface (UI) components 520 allowing the user to perform various operations on the collection 510; for example, to sort the collection, to remove a tagged products, to add a user-note regarding a tagged product, to share information about a tagged product (or about the entire collection 510) with friends and/or through social networks, or the like. A “store(s)” button may be used to command the system to filter and show only tagged items that belong to a particular store; and a “brand(s)” button may be used to command the system to filter and show only tagged items that belong to a particular brand. A “spree(s)” button may command the system to show or edit one or more shopping spree(s), or may take the user to a screen or panel for viewing or creating or editing shopping spree(s).

Optionally, each one of the tagged products 511-513 may also comprise a symbol or UI component 531-533 (respectively) allowing the user to select or unselect the product or to perform other operations on a product. Optionally, scroll buttons 541-542 may be used to scroll or browse through a large collection 510 that does not fit entirely within a single screen.

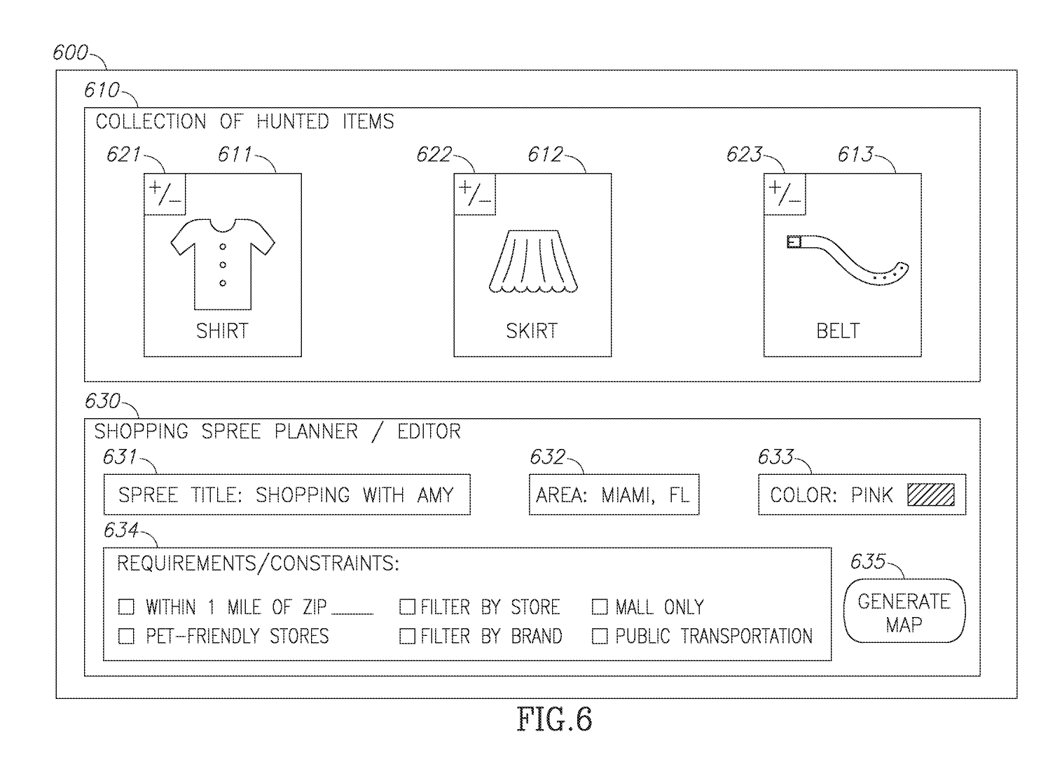

Reference is made to FIG. 6, which is a schematic illustration demonstrating adding of tagged products into a planned shopping spree, in accordance with some demonstrative embodiments of the present invention. A screen 600 of an electronic device (e.g., a laptop, a personal computer, a smartphone, a tablet) shows a collection 610 of previously-tagged products 611-613, each one having or associated with an add/remove button (621, 622, 623) allowing the user to selectively add a tagged product to a shopping spree (or to selectively remove an added product from the shopping spree).

The user may utilize a shopping spree planner/editor 630, to insert a shopping spree title 631; a geographical area 632 for the planned shopping spree (e.g., a name of a town or city, or a zip code); a color code 633 for the shopping spree; and may select other requirements or constraints 634 (e.g., public transportation, walking distance, radius or distance from a particular location, being within a shopping mall; filter by store; filter by brand; or the like). The user may then, or subsequently, command the system to generate a suggested shopping spree map via a “generate map” button 635.

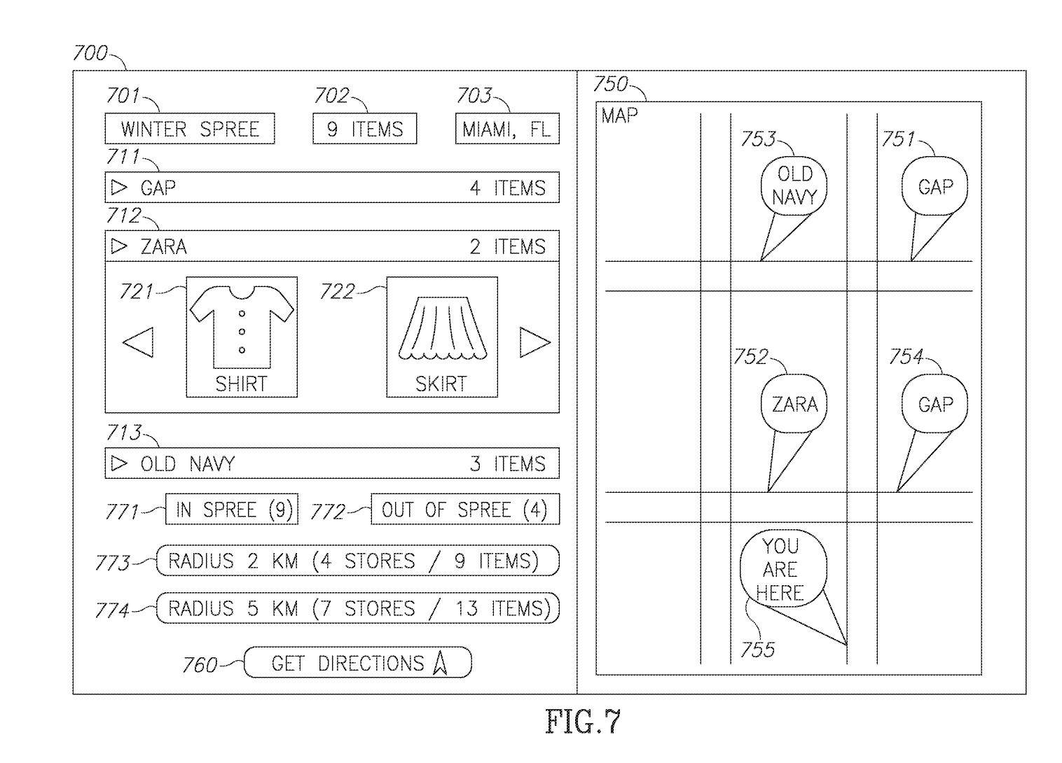

Reference is made to FIG. 7, which is a schematic illustration demonstrating a generated shopping spree map displayed on a screen 700 of an electronic device of the user, in accordance with some demonstrative embodiments of the present invention.

Screen 700 may comprise a shopping spree title 701, the number of products 702 included in this spree, and a geographical area-of-reference 703 around which (or, near which) the shopping spree was generated (e.g., a geographical location, or a street address, or a landmark location, or a name of a town or city or neighborhood, or a zip code).

In a first pane, names of three offline stores may be displayed: a first offline store 711, showing the store name, store address, and the number of items that are included in this spree and are available for purchase at this offline store 711; and similarly, a second offline store 712, and a third offline store 713.

The view may be expanded show the tagged items associated with each one of the offline stores 711-713. For example, offline store 712 is expanded, thereby showing to the user that this offline store 712 sells two previously-tagged items that are included in this spree, for example, a shirt 721 and a skirt 722. Optionally, clicking or tapping on a product image, may cause the screen 700 to display additional information about each such product (e.g., product price, product name).

In a second pane, a digital map 750 may be displayed, showing graphics and names of streets, avenues, roads, landmarks, and/or other suitable map data. An optional map pin 755 may indicate the current location of the user (e.g., if the map 750 is being shown on a mobile device). It is noted that the “you are here” map pin 755 is optional; and may not appear on the map 750 in some implementations; or may not appear if the map 750 is displayed on a non-mobile device (e.g., a desktop computer). In some embodiments, the “you are here” map pin 755 may not be displayed, and instead, the spree region may be displayed as a pre-defined radius or distance around a center point which is may be a user-defined address or landmark. In some embodiments, the system may inquire with the user, at which geographical location the user would like to shop (e.g., by indicating a zip code, or a town or city, or a neighborhood, or a landmark name (e.g., “Empire State Building”), or a street address); and the system may generate and display the shopping spree map within a user-defined radius or distance (e.g., 1 or 2 or 5 kilometers or miles) around or near such geographical point.

Multiple map pins 751-754 may indicate the map locations of the three offline stores 711-713 which may have three or more real-world locations; for example, offline store 711 may have two real-world locations in the desired geographical region and they may both be indicated using multiple pins, for example, map pins 751 and 754 indicating two different branches of the same offline store 711.

Optionally, next to each map pin 751-753, the name of the offline store may be displayed, and optionally, the name (or image) of one or more tagged products that are available for sale at such offline store. Optionally, the user may drag-and-drop the offline stores 711-713 to change their order (e.g., making the first offline store appear last, or similar re-arranging operations).

The user may click on (or tap, or select) the name of one of the displayed offline stores 711-713, and this may cause the map pins that correspond to that offline store to be highlighted or displayed in a different color (or other graphical effect, e.g., enlarged font, bold font), thereby distinguishing those map pins from other map pins that indicate other (non-selected) offline stores.

The user may select the radius or diameter or other region-defining parameter(s) of the spree, for example, by selecting or tapping or clicking-on one out of multiple Radius buttons. For example, a first radius button 773 may allow the user to select a radius of 2 kilometers for the spree, and the button may indicate that this radius will yield inclusion of 4 offline stores, and/or inclusion of 9 tagged items. Similarly, a second radius button 774 may allow the user to select a radius of 5 kilometers for the spree, and the button may indicate that this radius will yield inclusion of 7 offline stores, and/or inclusion of 13 tagged items. The user may command the system to switch between these other) radius or region-defining parameters, and the map may automatically be updated or modify to reflect these changes (e.g., changing the spree region; inclusion or highlighting of additional offline stores). In a demonstrative example, when the user selects the radius button 773 of 2 kilometers, a first information box 771 may indicate that this spree region includes 9 tagged items, and a second information box 772 may indicate that this spree region leaves 4 tagged items out of the scope of this spree.

The user may command the system, by using a “Get Directions” button 760, to generate turn-by-turn directions (e.g., driving directions, walking directions, public transportation directions) to take the user from his current location to the offline stores 711-713 in their order.

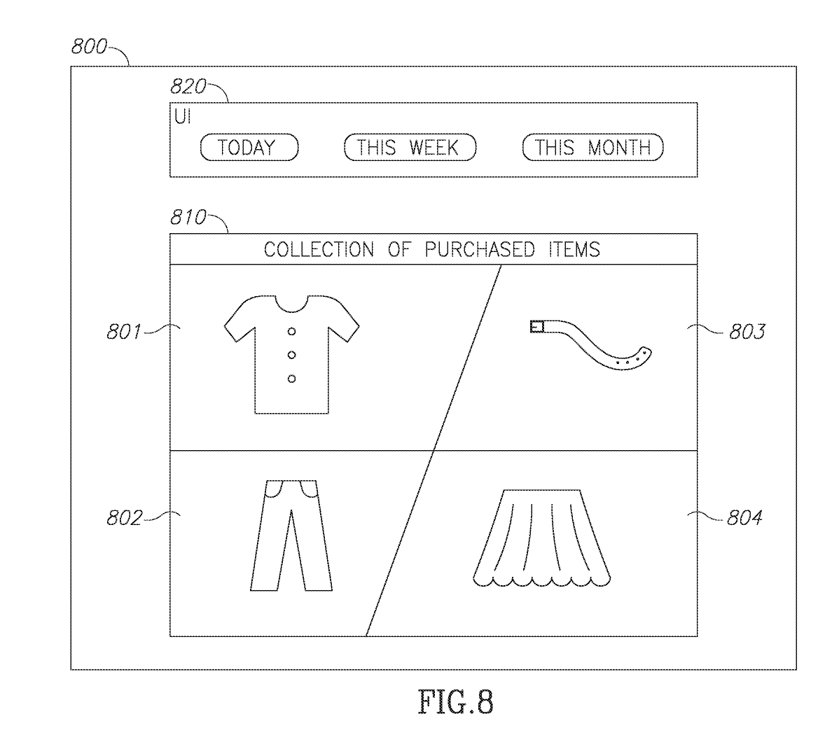

Reference is made to FIG. 8, which is a schematic illustration demonstrating a collection of tagged items that the user has already purchased, in accordance with some demonstrative embodiments of the present invention. A screen 800 of the electronic device of the user may show the collection 810 of purchased previously-tagged items, arranged in a list, a table, a matrix or array, a mash, a rotating carousel of images, a collage of images, or the like. In a demonstrative implementation, four purchased items 801-804 are depicted in a collage pattern.

Optionally, one or more UI elements 820 may be utilized to command the system to display the products purchased in a particular time-frame (e.g., today, yesterday, this week, this month, this year), or to sort or filter or show the purchased products based on other criteria (e.g., price, chronological order of purchase, product type, or the like).

Other suitable representations may be used in accordance with the present invention, utilizing text, graphics, animations, video, audio, UI elements, mapping elements, or the like.

It is clarified that some, or all, of the functionalities that are described above, may be implemented on a mobile device (e.g., a smartphone, a tablet), may be implemented or viewed through an “app” or application installed or running on a mobile device, may be generated locally on a mobile device, may he generated remotely on a remote server and then transmitted wirelessly to the mobile device for display, may be stored locally on the mobile device, or may otherwise be implemented (in whole or in part) by using a mobile device. For example, the user may utilize the mobile device in order to log-in (e.g., one time) to the Hunt system by using his unique username/password combination; and the mobile device may allow the user to view, on the mobile device, the collection of previously-tagged products (e.g., even if tagged on another device or on a desktop computer or laptop); and the mobile device may allow the user to view sprees and their corresponding digital map(s) and tagged product(s), and may optionally allow the user to edit or modify spree parameters on-the-go or on-the-fly from the mobile device; any may optionally allow the user to perform an actual or virtual “check in” operation into a real-world store, or to wirelessly receive coupons or promotions from such store, or to complete a purchase transaction electronically by using the mobile device. Other suitable operations or functionalities may be implemented in, or through, or by using, the mobile device.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may take the form of an entirely hardware embodiment, an entirely software embodiment, or an embodiment including both hardware and software elements. Some embodiments of the present invention may be implemented in software, firmware, resident software, microcode, an application which may be downloaded and/or installed by a user, an application which may run in a browser, a client-side application, a server-side application, a client-server application, or the like. Some embodiments of the present invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system or device. Some embodiments of the present invention may be implemented, for example, using a machine-readable medium or article which may store an instruction or a set of instructions that, if executed by a machine, cause the machine (e.g., a computer or an electronic device) to perform a method and/or operations described herein.

Some embodiments of the present invention may include or may utilize, for example, a processor, a central processing unit (CPU), a digital signal processor (DSP), a controller, an integrated circuit (IC), a memory unit, a storage unit, input units, output units, wired and/or wireless communication units, an operating system, and other suitable hardware components and/or software modules.

Some embodiments may be implemented as, or by utilizing, an application or “app” for a smartphone or tablet or portable computing device, which may be downloaded and/or installed onto such electronic device from an “app store” or an online marketplace for applications.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A method comprising:
receiving from a user of an electronic device, multiple selections of multiple products that are offered for sale online on multiple different websites;
receiving from the user of the electronic device an indication desired geographical location;
generating a digital map which shows multiple offline stores which (A) are located within a user-defined distance from the desired geographical location and also (B) offer for offline sale said multiple products.

2. The method of claim 1, comprising:
receiving from the electronic device of a user, a first user selection of an image of a first product offered for sale on a first online store;
storing in a repository a first record indicating at least (a) an identification of said first product, and (b) an identification of said first online store;
receiving from the electronic device of the user, a second user selection of an image of a second product offered for sale on a second online store;
storing in said repository a second record indicating at least (a) an identification of said second product, and (b) an identification of said second online store;
receiving from the user an indication of a desired geographical location;
determining a first location of a first offline store which is (A) associated with the first online store, and (B) is within a pre-defined distance from the desired geographical location;
determining a second location of a second offline store which is (A) associated with the second online store, and (B) is within said pre-defined distance from the desired geographical location;
generating a digital map indicating at least (i) the desired geographical location, (ii) the first location of the first offline store, (iii) the second location of the second offline store.

3. The method of claim 2, further comprising:
determining that the user is located indoor and within premises of he first location of the first offline store;
automatically displaying to the user, the first image of the first product.

4. The method of claim 3, further comprising::
while the user is located within the first location of the first offline store, generating a promotional proposal directed specifically to said user based on previous online selection of said first product by said user

5. The method of claim 3, further comprising:
automatically sending a notification to an electronic device of said first location of first offline store, notifying that (A) said user is within premises of said offline store, and (B) that said user had performed online selection of said first product.

6. The method of claim 5, further comprising:
if the user purchases said first product at said first offline store, sending a notification to said first location of said offline store, indicating that a commission is due for converting (A) a previous offline browsing and online tagging of the first product by the user, into (B) a current sale of said first product to said user at said first location of the offline store.

7. The method of claim 3, wherein determining that the user is located indoor and within premises of the first location of the first offline store comprises:
based on a user-initiated scanning of a two-dimensional barcode located in said first offline store, determining that the user is located indoor and within premises of the first location of the first offline store.

8. The method of claim 3, wherein determining that the user is located indoor and within premises of the first location of the first offline store comprises:
receiving from the user a notification that the user arrived to said first location of the first offline store.

9. The method of claim 3, wherein determining that the user is located indoor and within premises of the first location of the first offline store comprises:
based on Global Positioning System (GPS) data of said electronic device of said user, determining that the user is located within premises of the first location of the first offline store.

10. The method of claim 3, wherein determining that the user is located indoor and within premises of the first location of the first offline store comprises:
based on identification of a wireless communication network accessible from said first offline store, determining that the user is located within premises of the first location of the first offline store.

11. The method of claim 3, further comprising:
wirelessly receiving from said electronic device of said user, a user command to perform an online purchase of said first product from said first online store;
in response to said user command, initiating on behalf of said user an online purchase of said first product from said first online store which corresponds to said first offline store that said user is visiting.

12. The method of claim 2, wherein receiving from the electronic device the first user selection of the image of the first product comprises:
displaying on said electronic device, together with a web-page of said first online store, an on-screen toolbar onto which website images can be selectively dragged-and-dropped by said user via said electronic device;
receiving from the electronic device an indication that the user drags-and-drops the image of the first product onto said on-screen toolbar.

13. The method of claim 2, wherein receiving from the electronic device the first user selection of the image of the first product comprises:
displaying on said electronic device, together with a web-page of said first online store, a symbol overlaid on top of a portion of said image of the first product, wherein the symbol indicates to said user that said image can be selected;
receiving a user command via said electronic device, to select said symbol overlaid on top of said portion of said image of the first product.

14. The method of claim 2, comprising:
receiving from said user an indication that the first product is a mandatory product;
receiving from said user an indication that the second product is an optional product;
wherein the generating of the digital map comprises: generating the digital map which (A) includes the first offline store selling said mandatory product, and (B) excludes the second offline store selling said optional product.

15. The method of claim 2, comprising:
prior to generating the digital map, receiving from said electronic device a user-defined map generation constraint;
wherein the generating of the digital map conforms o the user-defined map generation constraint.

16. The method of claim 15, wherein the user-defined map generation constraint comprises a user requirement that offline stores on the digital map he within a pre-defined walking distance of each other.

17. The method of claim 15, wherein the user-defined map generation constraint comprises a user requirement that offline stores on the digital map he within a pre-defined driving distance of each other.

18. The method of claim 15, wherein the user-defined map generation constraint comprises a user requirement that offline stores on the digital map be accessible via a particular type of public transportation.

19. The method of claim 15, wherein the user-defined map generation constraint comprises a user requirement that offline stores on the digital map be within a particular single shopping mall.

20. The method of claim 2, comprising :
generating a first digital map indicating a first series of offline stores, which correspond to a first batch of online-tagged products that said user selected online;
generating a second, different, digital map indicating a second series of offline stores, which correspond to a second batch of online-tagged products that said user selected online.

21. The method of claim 20, wherein at least one particular online-tagged product, which the user tagged once online, appears in both first digital map and the second digital map.

22. The method of claim 2, comprising:
displaying on said digital map, (A) a name of the first product, in proximity to a first map pin indicating the on-map location of the first location of the first offline store, and (B) a name of the second product, in proximity to a second map pin indicating the map location of the second location of the second offline store.

23. The method of claim 2, comprising:
displaying on said digital map, (A) a miniature image of the first product, in proximity to a first map pin indicating the on-map location of the first location of the first offline store, and (B) a miniature image of the second product, in proximity to a second map pin indicating the map location of the second location of the second offline store.

24. The method of claim 2, further comprising:
generating turn-by-turn navigation directions, directing the user (A) from the current location of the user to the first location of the first offline store, and (B) from the first location of the first offline store to the second location of the second offline store.

25. The method of claim 1, comprising:
converting an online browsing of a product at a particular web-site, by said user, into a real-world purchase transaction that is subsequently performed by said user at a real-world store which corresponds to said particular web-site, based on information provided to said user through said electronic device.

26. The method of claim 1, comprising:
aggregating multiple selections that the user performs online, across multiple websites, into a list of cross-website tagged items;
generating and displaying to the user a digital map of real-world stores, which offer for sale at least a subset of said cross-website tagged items, within a user-defined radius around a particular geographic location.

27. The method of claim 1, comprising:
aggregating multiple selections that the user performs online, across multiple websites, into a list of cross-website tagged items;
generating and displaying to the user a digital map of real-world stores, which offer for sale all of said cross-website tagged items, within a user-defined radius around a particular geographic location.
